(19) United States
(12) Patent Application Publication
(10) Pub. No.: US 2005/0286928 A1
(43) Pub. Date: Dec. 29, 2005

(54) Apparatus for electronic component mounting

(75) Inventor: Akifumi Wada, Fukuoka-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Osaka (JP)

(21) Appl. No.: 11/153,299

(22) Filed: Jun. 15, 2005

(30) Foreign Application Priority Data
Jun. 23, 2004 (JP) 2004-184742

(51) Int. Cl. G03G 15/00

(52) U.S. Cl. 399/107; 399/13; 399/367; 399/392

(57) ABSTRACT

An object is to provide an apparatus for electronic component mounting which can precisely identify an option device which was attached and can certify authenticity thereof.

In a feeder 5 as an option device which is detachably attached to an electronic component loading apparatus which mounts electronic components on a substrate and used, a key code, which shows that the feeder 5 is a legitimate product, is stored in a key code storage section 16a which was disposed in a controller 16, and the key code is read out by a code reading section 12b from the key code storage section 16a in such a state that the feeder was connected to an apparatus main body, and the read key code is referred to data which was stored in a code data storage section 12a, and thereby, it is judged whether or not the feeder 5 is a legitimate product which should be connected to the apparatus main body.

### BACKGROUND OF THE INVENTION

1. Field of the Invention

This invention relates to an apparatus for electronic component mounting which is used in an electronic component mounting line for mounting electronic components on a substrate.

2. Description of the Related Art

An apparatus for electronic component mounting, which is used in an electronic component mounting line for mounting electronic components on a substrate, uses a number of option devices. For example, to an electronic component loading apparatus which mounts electronic components on a substrate, a parts feeder for supplying electronic components such as a tape feeder is attached according to types of components. As an apparatus to which plural kinds of the such like option devices are attached replaceably, one having a device type detecting function for automatically detecting what type of a device was attached has been known (e.g., see, JP-A-2001-135988 publication). An example, which is shown in this patent document, is configured in such a manner that an identification mark, which was attached to a parts feeder, is recognized by image pickup means, and thereby, a type of the parts feeder is detected.

In the meantime, as the above-described option device, one manufactured by the apparatus manufacturer or an authentic device which was produced under license legitimately should be used by nature. However, in an apparatus market, we can not always say that only authentic devices are distributed, and there is such a case that imitation devices, which were copied illegally, are supplied. The such like imitation device is imitated including the above-described identification mark, and therefore, it is not possible to precisely detect authenticity of a device which is used actually, by use of the device type detecting function which is shown in the above-described patent document example. In this manner, in a conventional apparatus for electronic component mounting, there was such a problem that it is difficult to identify an option device precisely and to certify authenticity thereof.

### SUMMARY OF THE INVENTION

Consequently, the invention aims to provide an apparatus for electronic component mounting which can precisely identify an option device which was attached, and can certify authenticity thereof.

An apparatus for electronic component mounting of the invention is an apparatus for electronic component mounting which is used in an electronic component mounting line for mounting electronic components on a substrate, and is equipped with an apparatus main body, an option device which is detachably connected to the apparatus main body, a key code storage section which stores a key code showing that the option device is a legitimate product, code reading means which reads out the key code from the key code storage section in such a sate that the option device was connected to the apparatus main body, and legitimacy judgment means which judges whether or not the option device is a legitimate option device which should be connected to the apparatus main body.

According to the invention, in the key code storage section which was attached to an option device, a key code, which shows that the option device is a legitimate product, is stored, and the key code is read out from the key code storage section in such a state that the option device was connected to the apparatus main body, and on the basis of the read key code, it is judged whether or not the option device is a legitimate option device which should be connected to the apparatus main body, and thereby, it is possible to precisely identify the option device which was attached and to certify authenticity thereof.

### BRIEF DESCRIPTION OF THE DRAWINGS

FIG.1 is a plan view of an electronic component loading apparatus of one embodiment of the invention.

FIG.2 is a configuration explanation view of a component supply section in the electronic component loading apparatus of one embodiment of the invention.

FIG. 3 is a block diagram which shows a configuration of a control system of the electronic component loading apparatus of one embodiment of the invention.

FIG. 4 is a flowchart of a tape feeder attachment processing in the electronic component loading apparatus of one embodiment of the invention.

### DESCRIPTION OF THE PREFERRED EMBODIMENTS

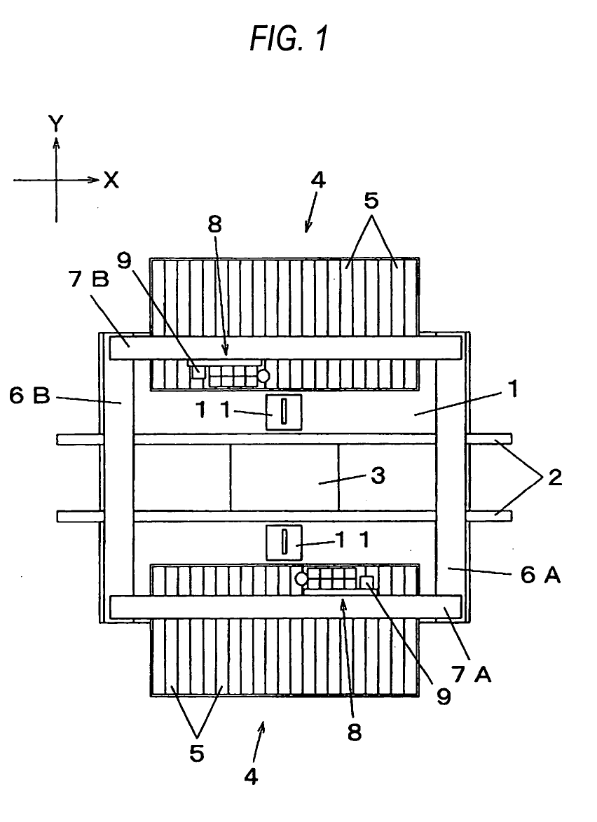

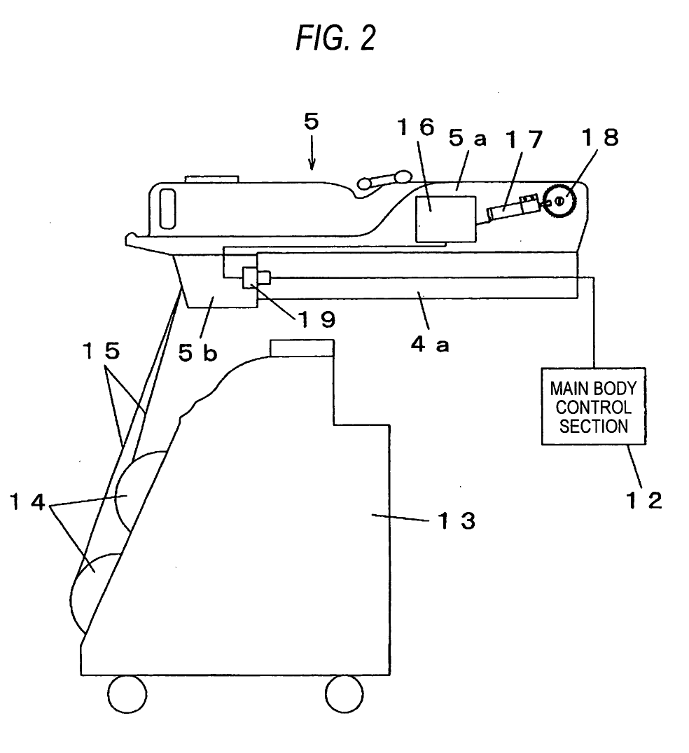

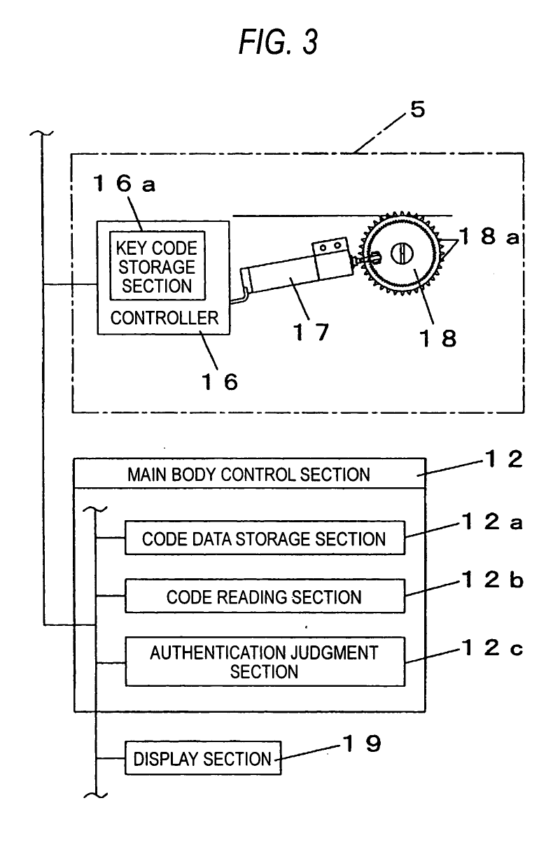

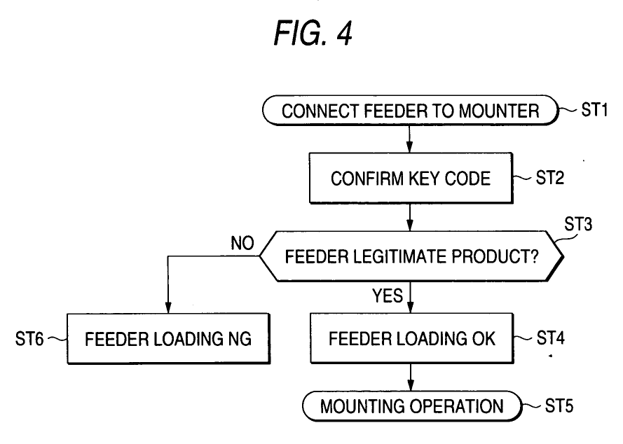

Next, an embodiment of the invention will be described with reference to drawings. FIG. 1 is a plan view of an electronic component loading apparatus of one embodiment of the invention, and FIG. 2 is a configuration explanation view of a component supply section in the electronic component loading apparatus of one embodiment of the invention, and FIG. 3 is a block diagram which shows a configuration of a control system of the electronic component loading apparatus of one embodiment of the invention, and FIG. 4 is a flow chart of a tape feeder attachment processing in the electronic component loading apparatus of one embodiment of the invention.

Firstly, with reference to FIG. 1, a configuration of the electronic component loading apparatus will be described. The electronic component loading apparatus is an apparatus for electronic component mounting which is used in an application for loading electronic components on a substrate to which solder printing was applied in a prior process, in an electronic component mounting line for mounting electronic components on a substrate.

In FIG. 1, at a center portion of a base 1, carrier paths 2 are disposed in a X direction. The carrier paths 2 become a substrate positioning section which conveys and locates a substrate 3. On both sides of the carrier path 2, component supply sections 4, which supply electronic components, are disposed, and in the component supply section 4, a plurality of parts feeder for supplying electronic components are disposed in parallel, and here, as the parts feeders, tape feeders 5 for supplying electronic components attached to a tape (hereinafter, simply abbreviated as “feeder 5”) are disposed.

On both end portions of an upper surface of the base 1, Y axis tables 6A, 6B are disposed, and on the Y axis tables 6A, 6B, two X axis tables 7A, 7B are installed. By driving the Y axis table 6A, the X axis table 7A moves horizontally in a Y direction, and by driving the Y axis table 6B, the X axis table 7B moves horizontally in the Y direction. To the X axis tables 7A, 7B, transfer heads 8 and cameras 9 which move integrally with the transfer heads 8 are attached respectively.

The Y axis table 6A, the X axis table 7A, the Y axis table 6B, and the X axis table 7B configure a head movement mechanism which moves the transfer heads 8, and by driving this head transfer mechanism, the transfer heads 8 move horizontally. Then, components are picked up from respective component supply sections 4 by absorption nozzles (omitted to be shown in the figure), and mounted on the substrate 3 which was located on the carrier paths 2. The cameras 9, which moved above the substrate 3, pick up an image of the substrate 3 and recognizes it. In addition, on routes which lead from the component supply sections 4 to the carrier paths 2, component recognition cameras 11 are disposed. The component recognition cameras 11 pick up images of electronic components in such a state that they were held by respective transfer head 8 from lower sides.

Next, with reference to FIG. 2, a configuration of the component supply section 4 will be described. To a feeder base 4a which was disposed in the component supply section 4, a plurality of feeders 5 are lined up in parallel and attached. The feeder 5 pulls out carrier tapes 15 which is holding electronic components, from a plurality of supply reels 14 which were set to a carriage 13 that is located on a lower side of the feeder base 4a, and supplies the held electronic components up to a pickup position by use of the transfer head 8.

The feeder 5 is loaded in such a manner that a lower surface of a main body portion 5a, which is a long and thin shaped frame member, moves along an upper surface of the feeder base 4a, and a locking portion 5b, which was disposed on a lower surface of the main body portion 5a, is locked together with an end portion of the feeder base 4a, and thereby, a position is fixed. Then, under this state, a controller 16, which was attached to the main body portion 5a, is to be connected to a main body control section 12 of the electronic component loading apparatus, through a connector 19 which was disposed on the locking portion 5b. The feeder 5 is an option device which is detachably connected to the main body control section 12 of the electronic component loading apparatus which is an apparatus main body, and is arbitrarily selected and used according to types of components etc., from a plurality of models having loading compatibility.

On a front end portion (right side in FIG. 2) of the feeder 5, a sprocket wheel 18 for tape feed and a motor 17 which drives to rotate the sprocket wheel 18 are disposed. Rotation of the motor 17 is controlled by the controller 16, and the sprocket wheel 18 rotates in a predetermined pattern, and thereby, the carrier tape 15 is pitch-fed by a feed pin 18a (see, FIG. 3) which was disposed on an outer circumference of the sprocket wheel 18.

Next, with reference to FIG. 3, a configuration of a control system will be described. Meanwhile, here, among constituent elements of the controller 16 and the main body control section 12, only an element regarding a function of identifying whether or not the feeder 5 as an option device is a legitimate product is shown. In FIG. 3, the controller 16 is equipped with a key code storage section 16a. The key code storage section 16a stores a key code for identifying whether the tape feeder 5 is a legitimate product or not.

Here, the legitimate product is one manufactured by the apparatus manufacturer which manufactured the electronic component loading apparatus or an authentic device which was produced under license legitimately, and the key code is a code such as production serial number which is specific to a frame of the option device, by which it is possible to certify that the device is a legitimate products. As a format of the key code, it is all right even if model/production serial number is arbitrarily encrypted and used.

In the main body control section 12, a code data storage section 12a, a code reading section 12b, and an authenticity judgment section 12c are disposed. The code data storage section 12a stores data of the above-described key code, i.e., a plurality of key codes which were give to legitimate products which are allowed to be connected to the electronic component loading apparatus.

By loading the feeder 5 in the component supply section 4, the code reading section 12b reads out a key code of the feeder 5, from the key code storage section 16a of the controller 16 which was connected to the main body control section 12. That is, the code reading section 12b becomes code reading means which reads out a key code from the code storage section 16a, in such a state that the feeder 5, which is an option device, was connected to the apparatus main body.

The authenticity judgment section 12c refers the key code which was read out by the code reading section 12b to data of a key code which was stored in the code data storage section 12a, and thereby, judges whether or not the feeder 5 is a legitimate product. That is, the authenticity judgment section 12c becomes authenticity judgment means which judges whether or not the feeder 5 is a legitimate option device which should be connected to the apparatus main body, on the basis of the key code which was read out. Then, a judgment result by the authenticity judgment section 12c is displayed on a display section 19 which was disposed on the apparatus main body.

Next, with reference to FIG. 4, processing on the occasion of attaching the feeder 5 to the electronic component loading apparatus will be described. Firstly, a new feeder 5 is connected to a mounter (electronic component loading apparatus) (ST1). By this means, the controller 5 of the feeder 5 is connected to the main body control section 12, and a key code is read out from the key code storage section 16a by the code reading section 12b and confirmed (ST2). Then, the authenticity judgment section 12c refers the confirmed key code to data which was stored in the code data storage section 12a, and thereby, judges whether or not the feeder is a legitimate product (ST3).

Here, if it was judged that it is a legitimate product, an authenticity judgment result is displayed on the display section 19 as feeder loading OK (ST4), and after this, amounting operation is carried out normally (ST5). In contrast to this, if it is judged that the feeder is not a legitimate product in (ST3), an authenticity judgment result is displayed on the display section 19 as feeder loading NG (ST4), and the apparatus stops without initiating the mounting operation.

In this manner, this embodiment is configured in such a manner that a key code, which shows that the device is a legitimate product, is stored in the key code storage section 16a which was incorporated in the tape feeder 5, and the key code is read out in such a state that the tape feeder 5 was connected to the apparatus main body, and it is judged whether or not the tape feeder 5 is a legitimate product which should be connected to the apparatus main body. By this means, loading compatibility on a hardware side is satisfied and even in case that it is unclear to decide whether or not it is an imitation device which was copied illegally, externally, it is possible to certify authenticity by precisely identifying the tape feeder 5 which was attached.

Meanwhile, this embodiment shows an example of judging authenticity by referring the read key code to code data which was stored in the main body control section 12 of the electronic component loading apparatus, but it is all right even if a key code such as model/production serial number is certified online, through a host system such as a centralized control system of an electronic component mounting line. Furthermore, it is also all right even if a device, which is not described in a list, is excluded, by referring to an authentic device serial number list which was held in an apparatus main body or a host system at a connection destination.

In addition, the above-described embodiment showed an example of the electronic component loading apparatus which loads electronic components on a substrate, as an apparatus for electronic component mounting, but besides this, if it is an apparatus which is in an electronic component mounting line such as a solder screen printing apparatus, an adhesive agent coating apparatus, and an external appearance inspection apparatus, it becomes an object to which the invention is applied. In addition, an example of the parts feeder which supplies electronic components was shown as an option device, but if it is a device which can be put on and taken from an apparatus for electronic component mounting, such as a nozzle and a transfer head which pick up electronic components from a parts feeder, it is an object to which the invention is applied.

An apparatus for electronic component mounting of the invention has such an advantage that it is possible to precisely identify an option device which was attached and to certify authenticity thereof, and is useful to an apparatus for electronic component mounting which is used in an electronic component mounting line and to which various option devices are connected.

1. An apparatus for electronic component mounting which is used in an electronic component mounting line for mounting electronic components on a substrate, comprising:
an apparatus main body;
an option device, which is detachably connected to the apparatus main body;
a key code storage section, which stores a key code showing that the option device is a legitimate product;
a code reader, which reads out the key code from the key code storage section in such a sate that the option device is connected to the apparatus main body; and
a legitimacy judging unit, which judges whether or not the option device is a legitimate option device which should be connected to the apparatus main body.

2. The apparatus for electronic component mounting, according to claim 1, wherein the key code storage section of the option device and a main body control section of the apparatus for electronic component mounting are connected through a connector.

3. The apparatus for electronic component mounting according to claim 1, wherein the code reader reads out a key code in such a state that the option device is connected to the main body of the apparatus for electronic component mounting.

4. The apparatus for electronic component mounting according to claim 1, comprising:
a host system, which carries out legitimacy judgment of the option device and is a centralized control system of an electronic component mounting line.

5. The apparatus for electronic component mounting according to claim 1, wherein the apparatus for electronic component mounting is an electronic component loading apparatus which loads electronic components on a substrate, and the option device is a plurality of parts feeders which were disposed in parallel in a component supply section.

6. The apparatus for electronic component mounting according to claim 1, wherein the apparatus for electronic component mounting is an electronic component loading apparatus which loads electronic components on a substrate, and the option device is a nozzle which picks up electronic components.

7. The apparatus for electronic component mounting according to claim 1, wherein the apparatus for electronic component mounting is an electronic component loading apparatus which loads electronic components on a substrate, and the option device is a transfer head which transfers and mounts electronic components on a substrate.
